(19) United States
(12) Patent Application Publication
(10) Pub. No.: US 2026/0170230 A1
(43) Pub. Date: Jun. 18, 2026

(54) FRAMEWORKS FOR SYNCHRONOUS LAYOUT ADJUSTMENT AND CONTINUOUS PAGINATION VISUALIZATION IN DIGITAL DOCUMENT EDITING APPLICATIONS

(71) Applicant: Bold Limited, Hamilton (BM)

(72) Inventors: Raghvender KATARIA, Bahadurgarh (IN); Katarzyna LATANOWICZ, Kalwy (PL); Deepika ADHIKARI, Noida (IN); Sudhir KUMAR, Delhi (IN); Antriksh ARORA, Ludhiana (IN)

(21) Appl. No.: 18/978,789

(22) Filed: Dec. 12, 2024

(51) Int. Cl. G06F 40/106; G06F 40/114; G06F 40/166

(52) U.S. Cl. CPC G06F 40/106; G06F 40/114; G06F 40/166

(57) ABSTRACT

Certain aspects of the disclosure provide a method of displaying pagination during document editing. In certain aspects, the method includes scanning a document to detect one or more columns, calculating a column height based on a first distance between a top edge of the document, and a first bottom edge of the each respective column, inserting a page break into the document by: calculating, for each sequential lines of text within each respective column, a text line, detecting a first sequential text line, where the text line height of the first sequential text line exceeds the column height of a respective column containing the first sequential text line, and inserting the page break into the document.

### INTRODUCTION

### Technical Field

Aspects of the present disclosure relate to systems and methods for synchronous layout adjustment and pagination visualization in digital document editing document editing applications.

### Background

Users frequently rely upon document editing applications for creating complex documents, such as resumes. Document editing applications may offer a variety of tools such as templates, formatting options, and customization features that simplify the design process and ensure professional results. These features are designed to help users create well-structured, visually appealing documents, without requiring advanced design skills. Displaying pagination is crucial during document creation and editing, as it provides a clear view of how content will be divided across pages, ensuring proper layout, alignment, and readability. Pagination allows a user to see if important information is cut off, or poorly placed, helping the user to create documents that are both functional and aesthetically polished.

### SUMMARY

Certain aspects provide a method of displaying pagination during document editing, the method including: scanning, within a document editing application, a document to detect one or more columns; calculating, for each respective column of the one or more columns, a column height based on a first distance between a top edge of the document, and a first bottom edge of the each respective column; storing the column height for the each respective column of the one or more columns in an array; inserting a page break into the document by: calculating, for each sequential lines of text within the each respective column, a text line height corresponding to a second distance between the top edge of the document, and a second bottom edge of a lowest positioned text element within the each sequential text line; detecting a first sequential text line, where the text line height of the first sequential text line exceeds the column height of a respective column containing the first sequential text line; and inserting the page break into the document, the page break positioned after a left-most element of a previous sequential text line preceding the first sequential text line; and generating a visual display element indicating a position of the page break, the visual display element displayed within an editable multi-page preview of the document editing application.

Another aspect provides a method of displaying pagination during document editing, the method including: displaying, within a document editing application, an editable preview displaying multiple pages of a document; detecting a user selected section of content within the document; generating a display element comprising a frame positioned around the user selected section of content; detecting user interaction comprising repositioning of the frame; in response detecting the user interaction, repositioning the user selected section of content from a first position within the document to a second position within the document; determining a position within the document to insert a page break by: scanning, within a document editing application, a document to detect one or more columns; calculating, for each respective column of the one or more columns, a column height based on a first distance between a top edge of the document, and a first bottom edge of the each respective column; storing the column height for the each respective column of the one or more columns in an array; detecting a user edit to content of the document; in response to detecting the user edit to the content of the document, inserting a page break into the document by: calculating, for each sequential lines of text within the each respective column, a text line height corresponding to a second distance between the top edge of the document, and a second bottom edge of a lowest positioned text element within the each sequential text line; detecting a first sequential text line, where the text line height of the first sequential text line exceeds the column height of the respective column containing the first sequential text line; and inserting the page break into the document, the page break positioned after a left-most element of a previous sequential text line preceding the first sequential text line; and generating a visual display element indicating a position of the page break within the preview comprising the multiple pages of the document.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an illustrative environment for implementing a pagination system according to one or more aspects shown and described herein.

FIG. 2 depicts an illustrative architecture for performing an example process implemented by a pagination system for displaying pagination by inserting page breaks according to one or more aspects shown and described herein.

FIG. 3 depicts an illustrative document being edited within a document editing application employing a pagination system for displaying pagination by inserting page breaks based on detected user edits according to one or more aspects shown and described herein.

FIG. 4 depicts the illustrative document of FIG. 3, which has had a page break inserted by a pagination system according to one or more aspects shown and described herein.

FIG. 5 depicts an illustrative document being edited within a document editing application employing a pagination system for displaying pagination by inserting page breaks based on detected user edits according to one or more aspects shown and described herein.

FIG. 6 depicts an illustrative document being edited within a document editing application employing a pagination system for displaying pagination by inserting page breaks based on detected user edits according to one or more aspects shown and described herein.

FIG. 7 depicts an illustrative document being edited within a document editing application employing a pagination system for displaying pagination by inserting page breaks based on detected user edits according to one or more aspects shown and described herein.

FIG. 8 depicts an example method for displaying pagination by inserting page breaks based on detected user edits according to one or more aspects shown and described herein.

FIG. 9 depicts an example processing system upon which one or more aspects shown and described herein may be implemented.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and computer-readable mediums for synchronous layout adjustment and pagination visualization in digital document editing. Aspects described herein insert page breaks into a document being edited based on column heights and text line heights to accurately display pagination within an editable multi-page preview of a document being edited within a document editing application. Aspects described herein further perform synchronous layout adjustment and pagination visualization in real-time as various edits and repositions are performed on the text of a document being edited.

Displaying pagination is crucial during document creation and editing, as it provides a clear view of how content will be divided across pages, ensuring proper layout, alignment, and readability. In some cases, a document must include a specific number of pages (e.g. document must be 2 pages, or document must be no more than 1 page) to meet various requirements, including legal requirements. Current document editing applications typically include single-page previews without any indication of how the content will be distributed across multiple pages when downloaded, viewed as a portable document format (PDF), or otherwise exported from the document editing platform. The user is thus unable to view pagination within an editable preview. This causes the user to expend extra time editing a document, and then switching to a preview capable of displaying pagination to confirm the document's structure and layout. Current document editing applications further provide simplistic editing capabilities when previewing content. For example, current document editing applications do not provide multiple page document previews that allow a user to drag and drop sections of text content from a first position to a second position within the document. Rather, current techniques typically involve a user making edits to the document in a first view, and subsequently viewing the pagination and overall structure of the document in a second view that can display pagination across multiple pages. This increases the time spent by the user switching between the different views and does not allow the user to easily visualize pagination of the document while making real-time edits.

In contrast, aspects described herein provide technical solutions to the shortcomings of current techniques by leveraging computing devices configured to generate a visual display element indicating a position of an inserted page break within an editable multi-page preview of a document. This allows users the ability to easily view, in real-time, positioning of different text elements within the document across multiple pages as they proceed with creating or editing a given document. Aspects herein further leverage computing devices for causing specially configured components to allow a user to edit sections of content, within a multiple page preview of the document, by moving content from a first position within a document to a second position within the document, inserting a new page break (based on the user edit) in real-time. Described aspects thus provide technical improvements and advantages over current techniques by allowing users to reformat or otherwise reposition sections of their document, within a multiple page preview, while continuously being shown clear visual indicators of pagination as it changes in real-time. Described aspects further perform synchronous layout adjustments as updated page breaks are inserted to maintain proper layout, alignment, and readability of different sections and columns within a document. This enables users to quickly assess the overall structure and layout of their document, enabling them to easily identify areas for improvement or adjustment, gauge the length of their document at a glance, and ensure their document adheres to industry standards or specific requirements set by employers.

Described aspects for displaying pagination within an editable multi-page preview of a document further provide for certain technical benefits. As an example, aspects described herein provide real-time layout management, inserting page breaks in real-time and ensuring document layouts remain coherent as the user edits the document within a singular multiple page preview for editing and viewing pagination. Described aspects thus provide the technical benefit of improved performance and response time within a document editing application by reducing state switching overhead associated with switching from a first editing view to a second view for displaying pagination. For example, described aspects reduce state switching overhead at least by reducing reloading of data, reducing recalculating of layouts, and reducing redrawing of document sections when switching between a first view for editing and a second view for displaying pagination (as is typical of current techniques.) Described aspects further provide the technical benefit of enabling a lower memory footprint for an associated document editing application, since there is no need to maintain two distinct views for editing and displaying pagination. Described aspects further provide system architecture for enabling a unified rendering pipeline for both editing and pagination, which provides the technical benefit of reducing complexity, and avoiding duplicate efforts to maintain multiple views in sync, leading to fewer bugs and more efficient processing. Described aspects further provide the technical benefit of improved accuracy in content flow management by ensuring edited content is properly redistributed across pages without disrupting logical or visual structures other formatting elements of the document. As an example, described aspects may calculate and insert new page breaks and then further ensure that headers, footers, text lines, and other formatting elements remain aligned correctly, ensuring integrity of a document's structure in the presence of real-time edits and updated page breaks. The aforementioned technical benefits provided by described aspects are merely illustrative. Additional technical benefits may be better understood in view of the illustrative aspects described below.

### Example Systems and Methods for Displaying Pagination

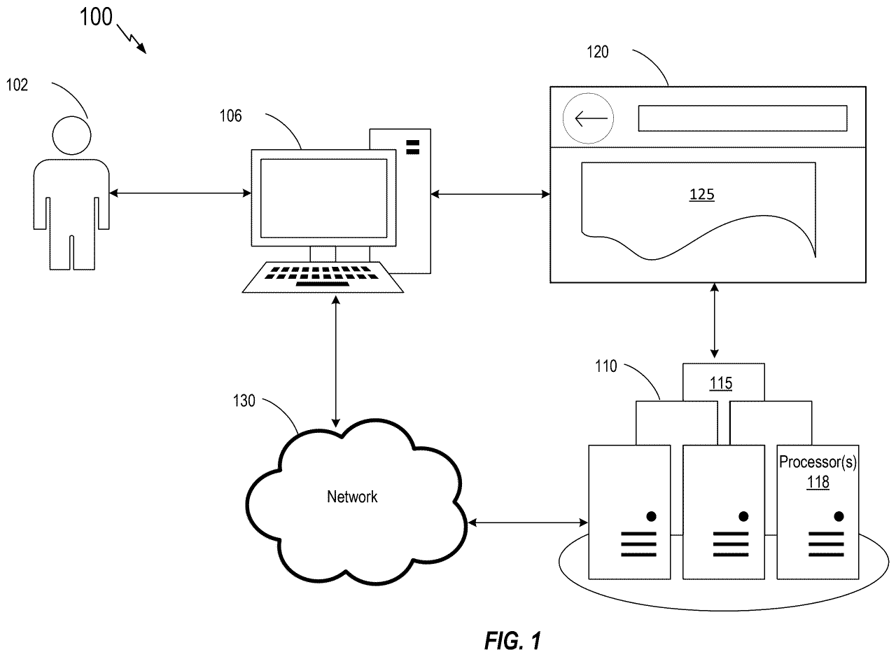

FIG. 1 depicts an illustrative environment for implementing a pagination system according to one or more aspects shown and described herein. The pagination system 110 may be configured to interface with a user 102 seeking to edit a document, such as a resume. User 102 may interface with aspects of pagination system 110, for example implemented by one or more computing devices, through a device 106. In certain aspects, device 106 may be a personal computer, a tablet computer, a smart device (e.g., a smartphone), or the like.

In certain aspects, device 106 includes a display device for implementing a user interface with the respective user, one or more processors for executing logic and one or more non-transitory computer-readable mediums for storing information and/or computer readable instructions. In certain aspects, device 106 operates as an interface for interacting with a document editing application 120 having a user interface 125. Device 106 may access document editing application via any suitable data network 130, such as the Internet. Document editing application 120 may be configured to communicate with and employ pagination system 110 to generate and display pagination to a user of document editing application 120 as they edit a document in real-time. In certain aspects, pagination system 110 performs processes for displaying pagination during document editing using one or more computing devices 115. The one or more computing devices 115 of pagination system 110 may include one or more processors 118 and one or more non-transitory computer-readable mediums storing computer readable instructions that, when executed by the one or more processors, cause the one or more computing devices to perform processes defined by computer-readable instructions corresponding to one or more components depicted and described herein.

In certain aspects, pagination system 110, is configured to perform processes to insert page breaks within a document preview that simultaneously displays multiple pages of the document being edited within a document editing application employing pagination system 110. Pagination system 110 is further configure to, in response to detecting user edits to the document, generate visual display elements allowing the user to reposition sections of the document. Pagination system 110 may then insert a new page break for displaying, in real-time, updated pagination based on the user edit including the repositioned sections. The aforementioned features of pagination system 110 will be better understood in view of the illustrative processes and figures described below.

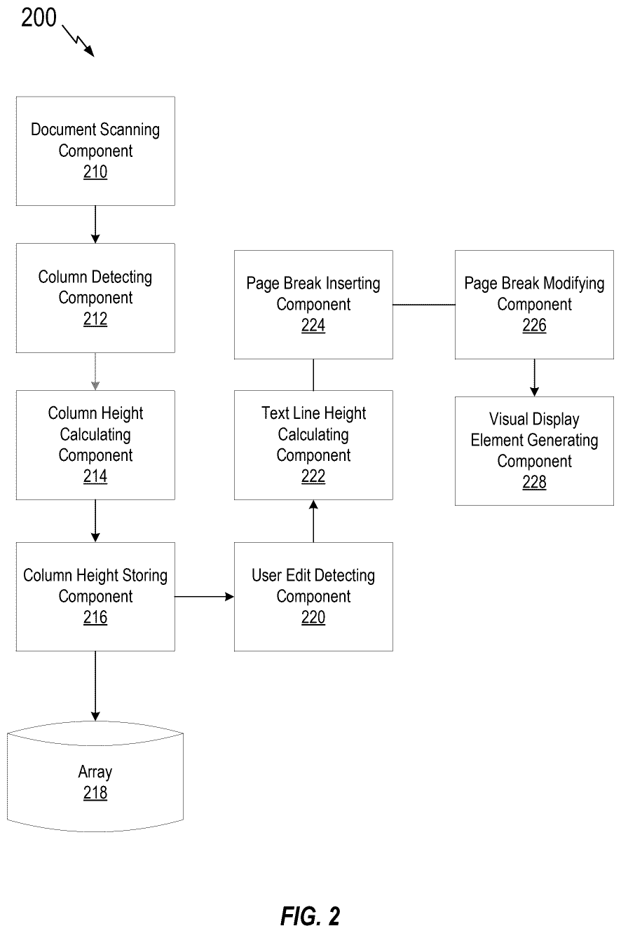

FIG. 2 depicts an illustrative architecture for performing an example process 200 implemented by a pagination system (such as pagination system 110 of FIG. 1) for displaying pagination by inserting page breaks according to one or more aspects shown and described herein.

First a document scanning component 210 of a pagination system scans a document being created or edited within a document editing application employing pagination system 110. In certain aspects, document scanning component 210 scans a document to detect document features including but not limited to, page size, margins, headers, footers, and sections of content having different types (e.g. text blocks, images and media, tables, embedded elements, etc.) for understanding structure and hierarchy of the document.

A column detecting component 212 of the pagination system then detects, based on the scan of the document, one or more columns within the document. Column detecting component 212 may utilize any known techniques for detecting columns within the document, detecting left and right sections for multi-column layouts, and the entire document for a single-column layout. In certain aspects, column detecting component 212 determines if the document includes explicit layout markers such as tab stops, margins, or gridlines defining columns. In some aspects, column detecting component 212 may be configured to leverage optical character recognition (OCR) to extract text and analyze its spatial positioning to detect columns within the document. In yet another aspect, column detecting component 212 may calculate bounding boxes for blocks of text, and compare x-axis coordinates of vertically aligned bounding boxes to group text into individual columns.

A column height calculating component 214 then calculates for each respective column of the document, a column height based on a first distance between a top edge of the document, and a first bottom edge of the each respective column. The top edge of the document may correspond to a top edge of printable space corresponding to a paper size associated with the document being edited. For example, column height calculating component 214 may generate a coordinate plane representation of the document having x-axis coordinates and y-axis coordinates. The calculated height for a respective column may then be calculated by determining a y-axis coordinate for a top edge of the document, and subtracting a y-axis coordinate corresponding to a bottom most element of the respective detected column. As an example, the bottom most element of a respective detected column may be a coordinate of a bottom most point of a bounding box corresponding to the respective detected column.

A column height storing component 216 of the pagination system then stores the calculated column heights for each of the detected columns of the document within an array 218. Array 218 contains a list of the calculated column heights within a data structure (e.g. using any suitable programming language, such as a python, JavaScript, etc.) accessible via an index.

A user edit detecting component 220 of the pagination system then detects whether a user edit has been made to the document via the document editing application. The detected user edit may include any modification to the document including adding content, removing content, repositioning content, reducing a size of content, enlarging content, reformatting content, employing a different template for displaying content, or any other user edit including a modification to the content of the document. As used herein, content may refer to any elements within the document including text elements, images, media, tables, forms, links, and any other elements that may be inserted via the document editing application employing pagination system 110.

The pagination system may be configured to employ an algorithm to determine and insert updated page breaks. The employed algorithm may be executed using different components. For example, the pagination system may utilize a text line height calculating component 222, page break inserting component 224, page break modifying component 226, and visual display element generating component 228 to determine and insert updated page breaks within a given document. An example process for utilizing the aforementioned components to employ an algorithm for inserting updated page breaks is described in greater detail below. The example process below details how described aspects determine and insert a page break in response to detecting a user edit to a document displayed within a document-editing application. However, in some examples, described aspects may be configured to perform similar processes to those described below in the absence of any detected user edits. For example, described aspects may perform similar processes to those described below to determine and insert page breaks in the absence of any detected user edits for a document that has been uploaded for displaying by a document-editing application employing described aspects. Accordingly, described aspects may determine and insert page breaks for a document displayed within a multi-page preview in the absence of any detected user edits to the document.

To insert a page break, first a text line height calculating component 222 of described aspects calculates a text height for each sequential line of text within each of the detected columns. In certain aspects, the text height for each sequential text line is calculated based on a distance between the top edge (based on its y-axis coordinate) of the document and a bottom edge of a lowest-positioned text element within a given line of text.

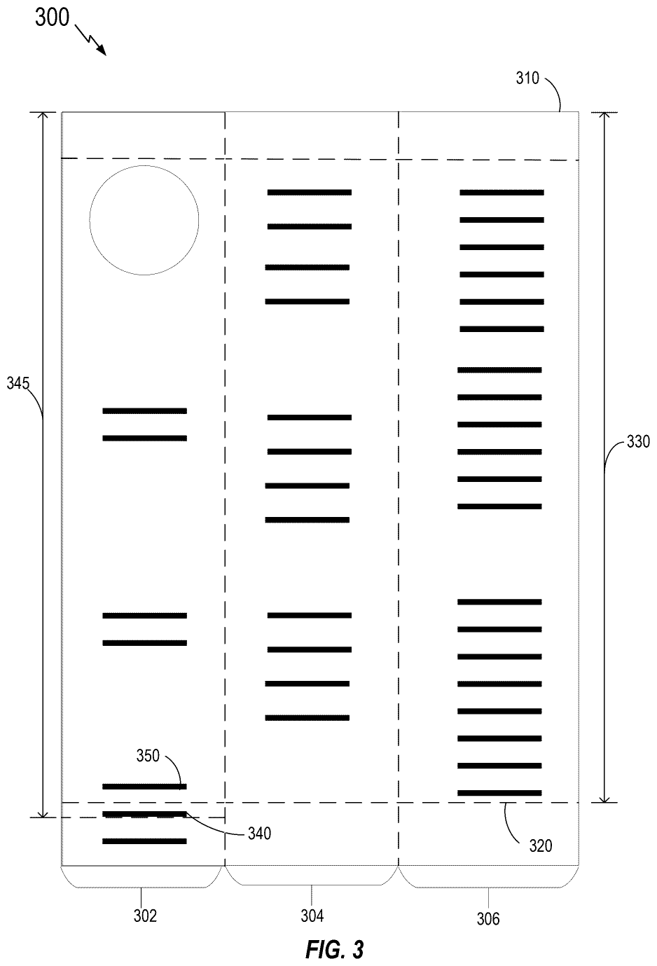

FIG. 3 depicts an illustrative document 300 being edited within a document editing application employing a pagination system, according to one or more aspects, for displaying pagination by inserting page breaks based on detected user edits. Document 300 includes three detected columns 302, 304, and 306. A calculated column height 330 for each of columns 302, 304, and 306 is depicted based on a distance between a top edge 310 of illustrative document 300 and a bottom edge of column 306. In response to detecting a user edit to illustrative document 300, the pagination system may then calculate a text height for each sequential line of text within each of the detected columns. As an example, text line height calculating component 222 of the pagination system may calculate a text line height 345 for a text line 340, calculated based on a distance between the top edge 310 of the illustrative document 300 and a bottom edge of a lowest-positioned text element within text line 340. In certain aspects, the lowest-positioned text element refers to any element (e.g. letter, symbol, number, etc.) within the text line that has an edge with a lowest-positioned y-axis coordinate with respect to the coordinate representation of the document. In certain aspects, the text line height calculating component 222 is configured look-up heights for given text elements or characters within a given text line within a table of characters (e.g. letters, symbols, numbers, etc.) having different cases, fonts, and formatting (e.g. lowercase, times, and bold.) The text line height calculating component 222 may then use the information from the table of characters to calculate the text line height based on the lowest-positioned text element.

Returning to FIG. 2, a page break inserting component 224 of the pagination system will detect a first sequential text line having a calculated text line height that exceeds the column height of the column in which it is positioned. Page break inserting component 224 will then insert a page break positioned after a left-most element of a previous sequential text line preceding the first sequential text line. As an example, FIG. 3 depicts a text line 340 having a text line height 345 that exceeds the column height 330 of the column 302 containing text line 340. Accordingly, page break inserting component 224 would insert a page break 320 after the preceding sequential line 350, causing the remaining text positioned after the page break to be moved to a new position within the document according to the position of the page break.

A page break modifying component 226 may then modify the page break to ensure other text elements across different columns within the document being edited remain visually appealing and well-structured. A visual display element generating component 228 may then generate a visual display element for inserting into the document to visually indicate, to the user, the inserted page break. The processes performed by page break inserting component 224, page break modifying component 226, and visual display element generating component 228 of pagination system 110 will be described in greater detail below.

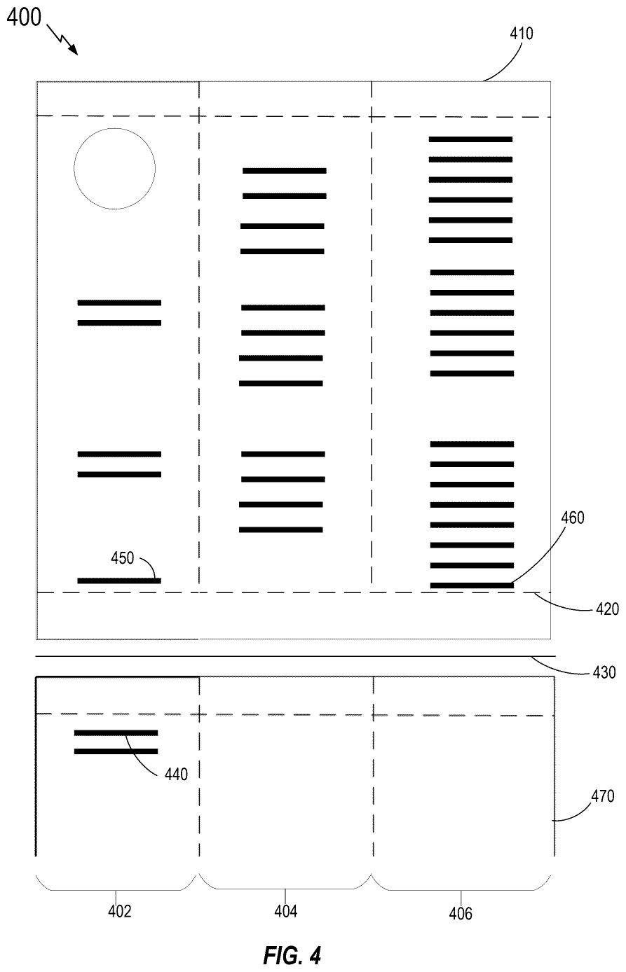

FIG. 4 depicts an illustrative document 400 representing the illustrative document 300 of FIG. 3, which has had a page break 420 inserted by a pagination system according to one or more aspects shown and described herein. Document 400 includes a first page 410 including three detected columns 402, 404, and 406. As shown, the page break inserting component 224 of the pagination system has inserted a page break after a text line 450. Text line 450 is a sequential text line of column 402 that immediately preceded text line 440, which previously had a text line height that exceeded the column height of column 402. Visual display element generating component 228 of the pagination system thus generated a visual display element 430 to indicate that the page break has been inserted. As shown, text line 440 (and any text that follows text line 440) is then repositioned to a second page 470 of illustrative document 400.

In certain aspects, as shown in FIG. 4, the inserted page break may leave certain text lines, such as text line 460 of column 406, in a position where text line 460 is positioned before the inserted page break, but is misaligned with other text lines preceding the inserted page break due to column 406 having its own individually positioned page break. Accordingly, in certain aspects, page break modifying component 226 of the pagination system may be configured to a apply suitable logic to match the Y-axis of the page breaks across the one or more detected columns to ensure horizontal alignment of the text lines between columns. Page break modifying component 226 may thus ensure that proper alignment, readability, and structure is maintained between different columns (and text contained therein) as updated page breaks are inserted by the pagination system.

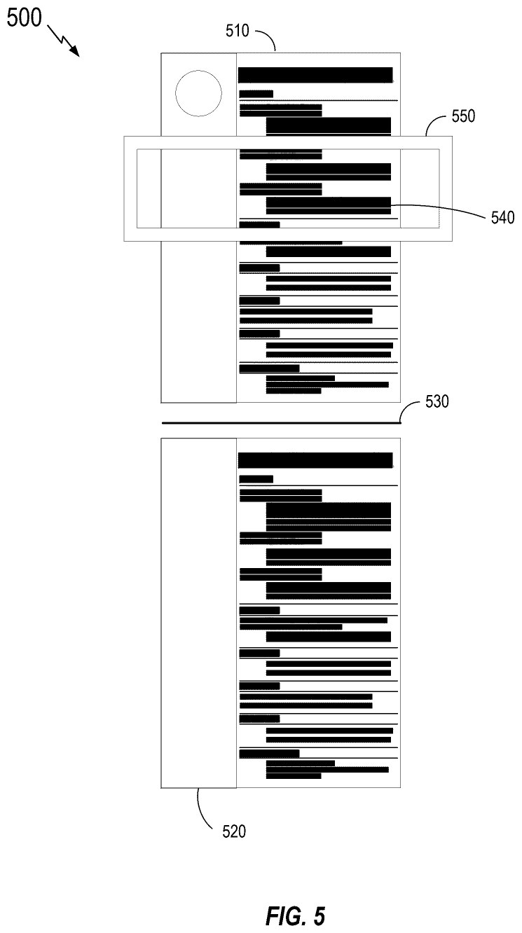

In certain aspects, in response to detecting a user edit to the document including selecting a section to be moved, visual display element generating component 228 of the pagination system may generate frames around the selected section. For example, if user edit detecting component 220 detects a user has selected a first paragraph of a document to be repositioned, visual display element generating component 228 may generate a frame positioned around the selected text. The generated frame may be configured to allow a user to delete, edit, or reposition the selected section of the document. FIG. 5 depicts an illustrative document being edited within a document editing application employing a pagination system for displaying pagination by inserting page breaks based on detected user edits according to one or more aspects shown and described herein. Document 500 is depicted including a first page 510, a visual display element 530 indicating an inserted page break, and a second page 520. As an example, the user edit detecting component (such as user edit detecting component 220 of FIG. 2) of the pagination system may detect a user selecting a section of text 540 of document 500 to be edited. In response to detecting the user selection of section of text 540, the visual display element generating component (such as visual display element generating component 228 of FIG. 2) of the pagination system may generate a frame 550 positioned around the section of text 540. Frame 550 may be configured to allow a user, via an interface of the document editing platform, to delete, reposition, or edit section of text 540 by interacting with features of the frame (e.g. buttons, icons, etc.) In certain aspects, the user may choose to reposition the section of text to the first page 510 of document 500 by dragging the section of text 540 (or the frame) to a desired position on the second page 520. In other words, the user of the document editing application may “drag and drop” the framed section of text to another position with the document. In some aspects, the pagination system may respond to detecting a user edit including a drag and dropped section of text by again performing illustrative process 200 to determine an appropriate position to insert a new page break. In certain aspects, the pagination system temporarily hides the previously existing page breaks while it performs illustrative processes (such as previously described illustrative process 200 of FIG. 2) to insert a new page break and perform any modifications to ensure proper alignment for formatting. As shown, the pagination system is configured to insert page breaks and generate visual display elements showing the inserted page breaks within a single preview that includes and simultaneously displays multiple pages of the document within the dimensions of the screen or monitor displaying the multiple-page preview. In certain aspects, the pagination system may temporarily hide an existing page break, and in response to the user dragging and dropping (editing the document) a section of text to a new position, insert a new page break to allow the user to view a modified multiple page preview of the document being edited.

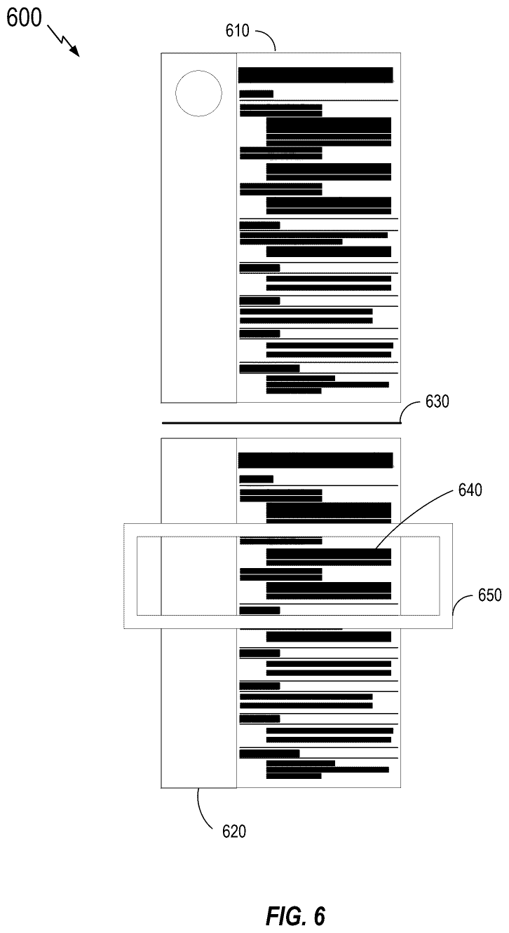

FIG. 6 depicts an illustrative document 600 being edited within a document editing application employing a pagination system 110 for displaying pagination by inserting page breaks based on detected user edits according to one or more aspects shown and described herein. More specifically, FIG. 6 depicts an updated illustrative document 600 corresponding to the document 500 of FIG. 5 having repositioned text based on user edits. As shown, the section of text 640 (originally section of text 540 positioned on first page 510 of FIG. 5) has been repositioned from a first page 610, to a region of a second page 620 of illustrative document 600 based on a user edit including a drag and drop of the section of text 640 contained within a frame 650. As discussed above, this user edit triggers the pagination system to perform illustrative process 200 to determine and insert an updated page break based on the user edit. It may be appreciated that generated visual display element 630 corresponds to a newly inserted page break based on the user edit to illustrative document 600. As previously discussed, the document editing application may then modify other existing page breaks (for example using the page break modifying component 226 of FIG. 2) to ensure that the columns and sections of text in the document remain aligned and appropriately formatted to maintain a professional look and feel for the document. Thus, the user of the document editing application employing the pagination system may easily view, in real-time, how the repositioning of the section of text 640 affects the structure and layout of the document.

Described aspects thus provide a single view (preview) for editing a document while displaying real time adjustments to pagination and simultaneously performing synchronous layout adjustment to maintain proper layout, alignment, and readability of different sections and columns within a document. Described aspects thus enable users to quickly assess the overall structure and layout of their document while making real-time edits to a given document within a singular view. This further enables users to easily identify areas for improvement or adjustment, gauge the length of their document at a glance, and ensure their document adheres to industry standards or specific requirements set by an organization. It may further be appreciated that described aspects provide the technical benefit of improved performance and response time within a document editing application by reducing state switching overhead associated with switching from a first editing view to a second view for displaying pagination. For example, described aspects provide reduce state switching overhead associated with current techniques at least by reducing reloading of data, reducing recalculating of layouts, and reducing redrawing of document when switching between a first view for editing and a second view for displaying pagination. Described aspects further provide the technical benefit of enabling a lower memory footprint for an associated document editing application, since there is no need to maintain two distinct views for editing and displaying pagination. Described aspects further provide system architecture for enabling a unified rendering pipeline for both editing and pagination, which provides the technical benefit of reducing complexity, and avoiding duplicate efforts to maintain multiple views in sync, leading to fewer bugs and more efficient processing

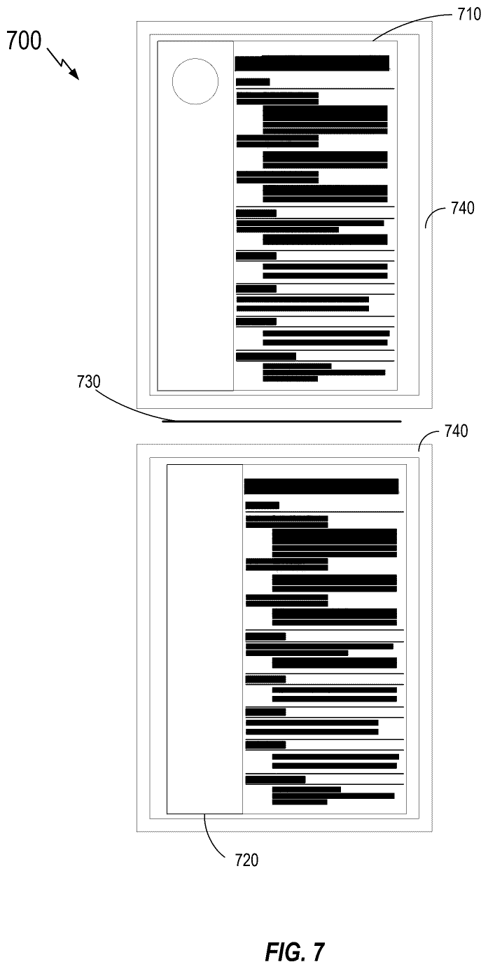

In certain aspects, as shown in FIG. 7, the visual display element generating component of the pagination system (such as visual display generating element 228 of FIG. 2) may be configured to generate a visual display element 740 including one or more frames around each page of an illustrative document 700 to help the user visualize the page breaks. In certain aspects, the pagination system may be configured to generate visual display elements 740 positioned around the visual display element 730 to enhance the sense of pagination within the document being edited, making it easier to distinguish between a first page 710 and a second page 720.

In certain aspects, the pagination system may be configured to perform methods of inserting page breaks during real-time editing of a document within a document editing application via execution of an external JavaScript. In certain aspects, the external JavaScript executed by the pagination system is not specific to any singular code base, but rather is integrated to a given document editing platform using an applicable code base (e.g. a web-based codebase corresponding to a given web-based document editing applications, a desktop-based codebase for desktop-based editing applications, etc.) for facilitating displaying of pagination in response to real-time user edits to the document being edited in the document editing application.

### Example Method for Displaying Pagination During Document Editing

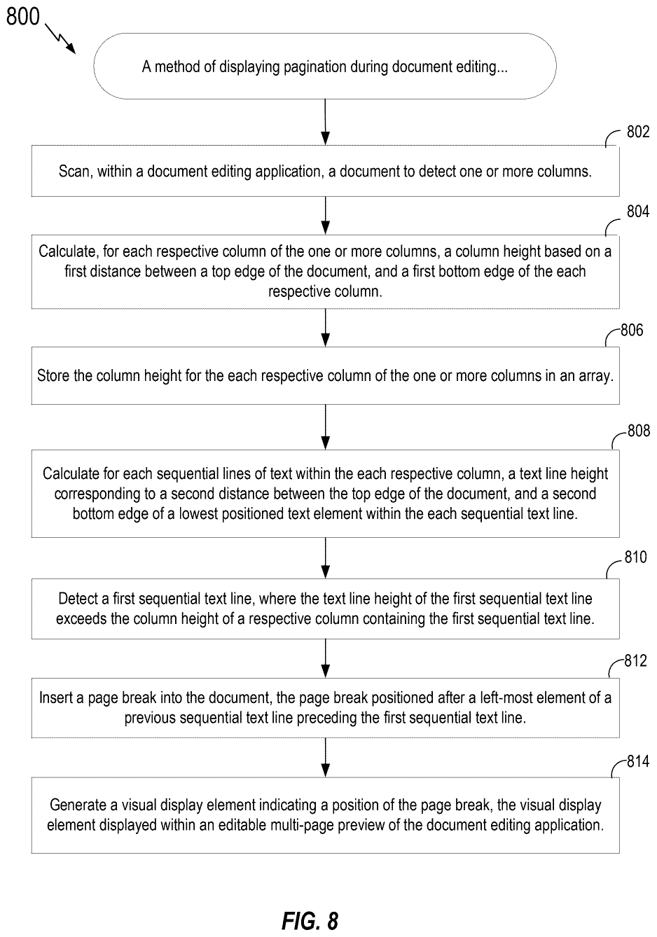

FIG. 8 depicts an example method 800 for providing job skill recommendations for an electronic document.

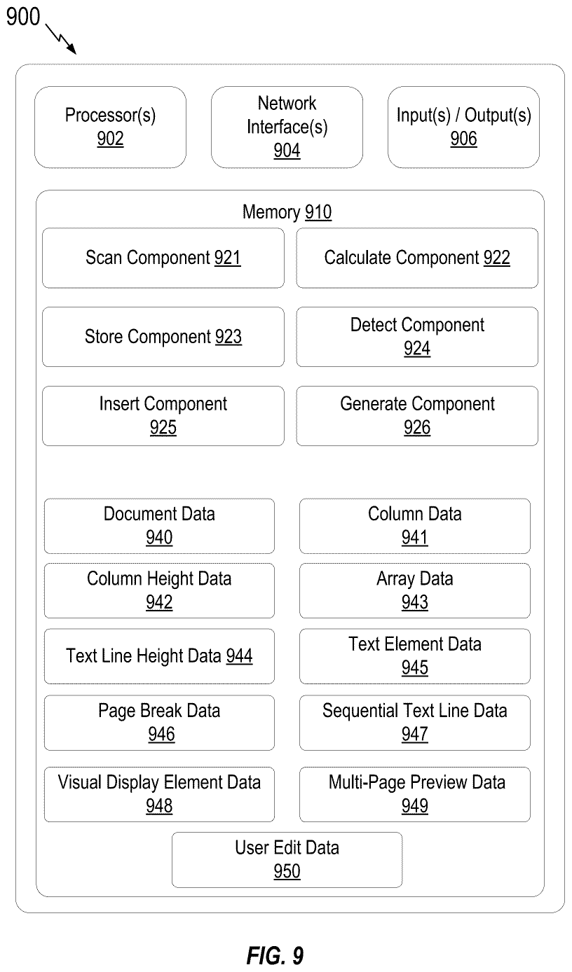

Method 800 begins at block 802 with scanning, within a document editing application, a document to detect one or more columns. For example, block 802 may be performed by the one or more processing systems 900 described below with reference to FIG. 9, configured to implement components including, but not limited to, the document scanning component 210 depicted and described with reference to FIG. 2.

Method 800 proceeds to block 804 with calculating, for each respective column of the one or more columns, a column height based on a first distance between a top edge of the document, and a first bottom edge of the each respective column. For example, block 804 may be performed by the one or more processing systems 900 described below with reference to FIG. 9, configured to implement components including, but not limited to, the column height calculating component 214 depicted and described with reference to FIG. 2.

Method 800 proceeds to block 806 with storing the column height for the each respective column of the one or more columns in an array. For example, block 806 may be performed by the one or more processing systems 900 described below with reference to FIG. 9, configured to implement components including, but not limited to, the column height storing component 216 depicted and described with reference to FIG. 2.

Method 800 proceeds to block 808 with=calculating, for each sequential lines of text within the each respective column, a text line height corresponding to a second distance between the top edge of the document, and a second bottom edge of a lowest positioned text element within the each sequential text line. For example, block 808 may be performed by the one or more processing systems 900 described below with reference to FIG. 9, configured to implement components including, but not limited to, the text line height calculating component 222 depicted and described with reference to FIG. 2.

Method 800 proceeds to block 810 with detecting a first sequential text line, where the text line height of the first sequential text line exceeds the column height of a respective column containing the first sequential text line. For example, block 810 may be performed by the one or more processing systems 900 described below with reference to FIG. 9, configured to implement components including, but not limited to, the page break inserting component 224 depicted and described with reference to FIG. 2.

Method 800 proceeds to block 812 with inserting a page break into the document, the page break positioned after a left-most element of a previous sequential text line preceding the first sequential text line. For example, block 812 may be performed by the one or more processing systems 900 described below with reference to FIG. 9, configured to implement components including, but not limited to, the page break inserting component 224 depicted and described with reference to FIG. 2.

Method 800 proceeds to block 814 with generating a visual display element indicating a position of the page break, the visual display element displayed within an editable multi-page preview of the document editing application. For example, block 814 may be performed by the one or more processing systems 900 described below with reference to FIG. 9, configured to implement components including, but not limited to, the visual display element generating component 228 depicted and described with reference to FIG. 2.

In some aspects, method 800 further includes detecting one or more additional page breaks associated with the one or more columns, wherein the one or more additional page breaks are misaligned horizontally with respect to the inserted page break, and modifying a vertical position of the one or more additional page breaks to horizontally align the one or more additional page breaks with the inserted page break.

In some aspects, method 800 further includes detecting a user selected section of content within the document, generating a second visual display element comprising a frame positioned around the user selected section of content, detecting user interaction comprising repositioning of the frame, and in response detecting the user interaction, repositioning the user selected section of content from a first position within the document to a second position within the document.

In some aspects, method 800 further includes in response to detecting the user interaction, temporarily hiding one or more existing page breaks within the document.

In some aspects, method 800 further includes replacing the one or more existing page breaks with a second page break by: scanning, within the document editing application, the document, detecting, in the document, the one or more columns, calculating, for the each respective column of the one or more columns, the column height based on the first distance between the top edge of the document, and the first bottom edge of the each respective column, storing the column height for the each respective column of the one or more columns in an array, detecting a user edit to content of the document, in response to detecting the user edit to the content of the document, inserting the second page break into the document by: calculating, for the each sequential lines of text within the each respective column, the text line height corresponding to the second distance between the top edge of the document, and the second bottom edge of the lowest positioned text element within the each sequential text line, detecting the first sequential text line, where the text line height of the first sequential text line exceeds the column height of the respective column containing the first sequential text line, and inserting the second page break into the document, the second page break positioned after the left-most element of the previous sequential text line preceding the first sequential text line, and generating the visual display element indicating the position of the page break.

In some aspects, method 800 further includes generating a second visual display element comprising a frame positioned around the inserted page break. In some aspects, the visual display element indicating the position of the page break is generated by executing a JavaScript.

In some aspects, method 800 further includes detecting, within a preview of the document, a scroll position of a user previewing the document, the scroll position comprising a perspective view of a region of the document within the preview of the document; and maintaining, after inserting the page break into the document, the scroll position of the user.

Method 800 thus provides technical solutions and advantages over conventional techniques by allowing users to reformat or otherwise reposition sections of their document within a singular multiple page preview, while continuously being shown clear visual indicators of pagination, and how the pagination changes in real-time based on the user edits. This enables users to quickly assess the overall structure and layout of their document, enabling them to easily identify areas for improvement or adjustment, gauge the length of their document at a glance, and ensure their document adheres to industry standards or specific requirements set by employers. Method 800 thus provide the technical benefit of improved performance and response time within a document editing application by reducing state switching overhead associated with switching from a first editing view to a second view for displaying pagination. For example, method 800 provide reduced state switching overhead at least by reducing reloading of data, reducing recalculating of layouts, and reducing redrawing of document sections when switching between a first view for editing and a second view for displaying pagination. Described aspects further provide the technical benefit of enabling a lower memory footprint for an associated document editing application, since there is no need to maintain two distinct views for editing and displaying pagination. Described aspects further provide system architecture for enabling a unified rendering pipeline for both editing and pagination, which provides the technical benefit of reducing complexity, and avoiding duplicate efforts to maintain multiple views in sync, leading to fewer bugs and more efficient processing. Described aspects further provide the technical benefit of improved accuracy in content flow management by ensuring edited content is properly reflowed across pages without disrupting logical or visual structures other formatting elements of the document.

Note that FIG. 8 is just one example of a method, and other methods including fewer, additional, or alternative steps are possible consistent with this disclosure.

### Example Processing System for Displaying Pagination During Document Editing

FIG. 9 depicts an example processing system upon which one or more aspects shown and described herein may be implemented.

The processing system 900 includes one or more processors 902. Generally, processor(s) 902 may be configured to execute computer-executable instructions (e.g., software code) to perform various functions, as described herein.

The processing system 900 further includes a network interface(s) 904, which generally provides data access to any sort of data network, including personal area networks (PANs), local area networks (LANs), wide area networks (WANs), the Internet, and the like.

The processing system 900 further includes input(s) and output(s) 906, which generally provide means for providing data to and from the processing system 900, such as via connection to computing device peripherals, including user interface peripherals.

The processing system 900 further includes a memory 910 configured to store various types of components and data.

In this example, memory 910 includes a scan component 921, a calculate component 922, a store component 923, a detect component 924, an insert component 925, and a generate component 926.

Scan component 921 may be configured to perform processes, for example, corresponding to block 802 of method 800 depicted and described with reference to FIG. 8.

Calculate component 922 may be configured to perform processes, for example, corresponding to block 808 of method 800 depicted and described with reference to FIG. 8.

Store component 923 may be configured to perform processes, for example, corresponding to block 806 of method 800 depicted and described with reference to FIG. 8.

Detect component 924 may be configured to perform processes, for example, corresponding to block 810 of method 800 depicted and described with reference to FIG. 8.

Insert component 925 may be configured to perform processes, for example, corresponding to block 812 of method 800 depicted and described with reference to FIG. 8.

Generate component 926 may be configured to perform processes, for example, corresponding to block 814 of method 800 depicted and described with reference to FIG. 8.

In this example, memory 910 also includes document data 940, column data 941, column height data 942, array data 943, text line height data 944, text element data 945, page break data 946, sequential text line data 947, visual display element data 948, multi-page preview data 949, and user edit data 950.

The processing system 900 may be implemented in various ways. For example, the processing system 900 may be implemented within on-site, remote, or cloud-based computing devices.

The processing system 900 is just one example, and other configurations are possible. For example, in alternative aspects, aspects described with respect to the processing system 900 may be omitted, added, or substituted for alternative aspects

### Example Clauses

Implementation examples are described in the following numbered clauses:

Clause 1: A method comprising: A method of displaying pagination during document editing, the method comprising: scanning, within a document editing application, a document to detect one or more columns; calculating, for each respective column of the one or more columns, a column height based on a first distance between a top edge of the document, and a first bottom edge of the each respective column; storing the column height for the each respective column of the one or more columns in an array; inserting a page break into the document by: calculating, for each sequential lines of text within the each respective column, a text line height corresponding to a second distance between the top edge of the document, and a second bottom edge of a lowest positioned text element within the each sequential text line; detecting a first sequential text line, where the text line height of the first sequential text line exceeds the column height of a respective column containing the first sequential text line; and inserting the page break into the document, the page break positioned after a left-most element of a previous sequential text line preceding the first sequential text line; and generating a visual display element indicating a position of the page break, the visual display element displayed within an editable multi-page preview of the document editing application.

Clause 2: The method of Clause 1, further comprising: detecting one or more additional page breaks associated with the one or more columns, wherein the one or more additional page breaks are misaligned horizontally with respect to the inserted page break; and modifying a vertical position of the one or more additional page breaks to horizontally align the one or more additional page breaks with the inserted page break.

Clause 3: The method of Clause 2, further comprising: detecting a user selected section of content within the document; generating a second visual display element comprising a frame positioned around the user selected section of content; detecting user interaction comprising repositioning of the frame; and in response detecting the user interaction, repositioning the user selected section of content from a first position within the document to a second position within the document.

Clause 4: The method of any of Clauses 1-3, further comprising, in response to detecting the user interaction, temporarily hiding one or more existing page breaks within the document.

Clause 5: The method of any of Clauses 1-4, further comprising: replacing the one or more existing page breaks with a second page break by: scanning, within the document editing application, the document, detecting, in the document, the one or more columns, calculating, for the each respective column of the one or more columns, the column height based on the first distance between the top edge of the document, and the first bottom edge of the each respective column, storing the column height for the each respective column of the one or more columns in an array, detecting a user edit to content of the document, in response to detecting the user edit to the content of the document, inserting the second page break into the document by: calculating, for the each sequential lines of text within the each respective column, the text line height corresponding to the second distance between the top edge of the document, and the second bottom edge of the lowest positioned text element within the each sequential text line, detecting the first sequential text line, where the text line height of the first sequential text line exceeds the column height of the respective column containing the first sequential text line, and inserting the second page break into the document, the second page break positioned after the left-most element of the previous sequential text line preceding the first sequential text line, and generating the visual display element indicating the position of the page break.

Clause 6: The method of any of Clauses 1-5, further comprising generating a second visual display element comprising a frame positioned around the inserted page break.

Clause 7: The method of any of Clauses 1-6, further comprising: detecting a user edit to content of the document; and in response to detecting the user edit to the content of the document, inserting the page break into the document.

Clause 8: The method of any of Clauses 1-7, further comprising: detecting, within a preview of the document, a scroll position of a user previewing the document, the scroll position comprising a perspective view of a region of the document within the preview of the document; and maintaining, after inserting the page break into the document, the scroll position of the user.

Clause 9: A method of displaying pagination during document editing, the method comprising: displaying, within a document editing application, an editable preview displaying multiple pages of a document; detecting a user selected section of content within the document; generating a display element comprising a frame positioned around the user selected section of content; detecting user interaction comprising repositioning of the frame; in response detecting the user interaction, repositioning the user selected section of content from a first position within the document to a second position within the document; determining a position within the document to insert a page break by: scanning, within a document editing application, a document to detect one or more columns; calculating, for each respective column of the one or more columns, a column height based on a first distance between a top edge of the document, and a first bottom edge of the each respective column; storing the column height for the each respective column of the one or more columns in an array; detecting a user edit to content of the document; in response to detecting the user edit to the content of the document, inserting a page break into the document by: calculating, for each sequential lines of text within the each respective column, a text line height corresponding to a second distance between the top edge of the document, and a second bottom edge of a lowest positioned text element within the each sequential text line; detecting a first sequential text line, where the text line height of the first sequential text line exceeds the column height of the respective column containing the first sequential text line; and inserting the page break into the document, the page break positioned after a left-most element of a previous sequential text line preceding the first sequential text line; and generating a visual display element indicating a position of the page break within the preview comprising the multiple pages of the document.

Clause 11: The method of Clause 10, further comprising: detecting one or more additional page breaks associated with the one or more columns, wherein the one or more additional page breaks are misaligned horizontally with respect to the inserted page break; and modifying a vertical position of the one or more additional page breaks to horizontally align the one or more additional page breaks with the inserted page break.

Clause 12: The method of Clause 11, further comprising, in response to detecting the user interaction, temporarily hiding one or more existing page breaks within the document.

Clause 13: The method of any of Clauses 10-12, wherein the visual display element indicating the position of the page break is generated by executing a JavaScript.

Clause 14: A processing system, comprising means for performing a method in accordance with any one of Clauses 1-13.

Clause 15: A non-transitory computer-readable medium comprising computer-executable instructions that, when executed by one or more processors of a processing system, cause the processing system to perform a method in accordance with any one of Clauses 1-13.

Clause 16: A computer program product embodied on a computer-readable storage medium comprising code for performing a method in accordance with any one of Clauses 1-13.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of displaying pagination during document editing, the method comprising:
scanning, within a document editing application, a document to detect one or more columns;
calculating, for each respective column of the one or more columns, a column height based on a first distance between a top edge of the document, and a first bottom edge of the each respective column;
storing the column height for the each respective column of the one or more columns in an array;
inserting a page break into the document by:
calculating, for each sequential lines of text within the each respective column, a text line height corresponding to a second distance between the top edge of the document, and a second bottom edge of a lowest positioned text element within the each sequential text line;
detecting a first sequential text line, where the text line height of the first sequential text line exceeds the column height of a respective column containing the first sequential text line; and
inserting the page break into the document, the page break positioned after a left-most element of a previous sequential text line preceding the first sequential text line; and
generating a visual display element indicating a position of the page break, the visual display element displayed within an editable multi-page preview of the document editing application.

2. The method of claim 1, further comprising:
detecting one or more additional page breaks associated with the one or more columns, wherein the one or more additional page breaks are misaligned horizontally with respect to the inserted page break; and
modifying a vertical position of the one or more additional page breaks to horizontally align the one or more additional page breaks with the inserted page break.

3. The method of claim 1, further comprising:
detecting a user selected section of content within the document;
generating a second visual display element comprising a frame positioned around the user selected section of content;
detecting user interaction comprising repositioning of the frame; and
in response detecting the user interaction, repositioning the user selected section of content from a first position within the document to a second position within the document.

4. The method of claim 3, further comprising, in response to detecting the user interaction, temporarily hiding one or more existing page breaks within the document.

5. The method of claim 4, further comprising replacing the one or more existing page breaks with a second page break by:
scanning, within the document editing application, the document;
detecting, in the document, the one or more columns;
calculating, for the each respective column of the one or more columns, the column height based on the first distance between the top edge of the document, and the first bottom edge of the each respective column;
storing the column height for the each respective column of the one or more columns in an array;
detecting a user edit to content of the document;
in response to detecting the user edit to the content of the document, inserting the second page break into the document by:
calculating, for the each sequential lines of text within the each respective column, the text line height corresponding to the second distance between the top edge of the document, and the second bottom edge of the lowest positioned text element within the each sequential text line;
detecting the first sequential text line, where the text line height of the first sequential text line exceeds the column height of the respective column containing the first sequential text line; and
inserting the second page break into the document, the second page break positioned after the left-most element of the previous sequential text line preceding the first sequential text line; and
generating the visual display element indicating the position of the page break.

6. The method of claim 1, further comprising generating a second visual display element comprising a frame positioned around the inserted page break.

7. The method of claim 1, further comprising:
detecting a user edit to content of the document; and
in response to detecting the user edit to the content of the document, inserting the page break into the document.

8. The method of claim 1, further comprising:
detecting, within a preview of the document, a scroll position of a user previewing the document, the scroll position comprising a perspective view of a region of the document within the preview of the document; and
maintaining, after inserting the page break into the document, the scroll position of the user.

9. A processing system for displaying pagination during document editing, comprising:
one or more memories comprising computer-executable instructions; and
one or more processors configured to execute the computer-executable instructions causing the processing system to:
scan, within a document editing application, a document to detect one or more columns;
calculate, for each respective column of the one or more columns, a column height based on a first distance between a top edge of the document, and a first bottom edge of the each respective column;
store the column height for the each respective column of the one or more columns in an array;
insert a page break into the document by:
calculating, for each sequential lines of text within the each respective column, a text line height corresponding to a second distance between the top edge of the document, and a second bottom edge of a lowest positioned text element within the each sequential text line;
detecting a first sequential text line, where the text line height of the first sequential text line exceeds the column height of the respective column containing the first sequential text line; and
inserting the page break into the document, the page break positioned after a left-most element of a previous sequential text line preceding the first sequential text line; and
generating a visual display element indicating a position of the page break, the visual display element displayed within a multi-page preview of the document editing application.

10. The processing system of claim 9, wherein the one or more processors are further configured to cause the processing system to:
detect one or more additional page breaks associated with the one or more columns, wherein the one or more additional page breaks are misaligned horizontally with respect to the inserted page break; and
modify a vertical position of the one or more additional page breaks to horizontally align the one or more additional page breaks with the inserted page break.

11. The processing system of claim 9, wherein the one or more processors are further configured to cause the processing system to:
detect a user selected section of content within the document;
generate a second visual display element comprising a frame, the frame positioned around the user selected section of content;
detect user interaction comprising repositioning of the frame; and
in response detecting the user interaction, reposition the user selected section of content from a first position within the document to a second position within the document.

12. The processing system of claim 11, wherein the one or more processors are further configured to cause the processing system to, in response to detecting the user interaction, temporarily hide one or more existing page breaks within the document.

13. The processing system of claim 12, wherein the one or more processors are further configured to cause the processing system replace the one or more existing page breaks with a second page break by:
scanning, within the document editing application, the document;
detecting, in the document, the one or more columns;
calculating, for the each respective column of the one or more columns, the column height based on the first distance between the top edge of the document, and the first bottom edge of the each respective column;
storing the column height for the each respective column of the one or more columns in an array;
detecting a user edit to content of the document;
in response to detecting the user edit to the content of the document, inserting the second page break into the document by:
calculating, for the each sequential lines of text within the each respective column, the text line height corresponding to the second distance between the top edge of the document, and the second bottom edge of the lowest positioned text element within the each sequential text line;
detecting the first sequential text line, where the text line height of the first sequential text line exceeds the column height of the respective column containing the first sequential text line; and
inserting the second page break into the document, the second page break positioned after the left-most element of the previous sequential text line preceding the first sequential text line; and
generating the visual display element indicating the position of the page break.

14. The processing system of claim 9, wherein the one or more processors are further configured to cause the processing system to generate a second visual display element comprising a frame positioned around the inserted page break.

15. The processing system of claim 9, wherein the one or more processors are further configured to cause the processing system to:
detect a user edit to content of the document; and
in response to detecting the user edit to the content of the document, insert the page break into the document.

16. The processing system of claim 9, wherein the one or more processors are further configured to cause the processing system to:
detect, within a preview of the document, a scroll position of a user previewing the document, the scroll position comprising a perspective view of a region of the document within the preview of the document; and
maintain, after inserting the page break into the document, the scroll position of the user.

17. A method of displaying pagination during document editing, the method comprising:
displaying, within a document editing application, an editable preview displaying multiple pages of a document;
detecting a user selected section of content within the document;
generating a display element comprising a frame positioned around the user selected section of content;
detecting user interaction comprising repositioning of the frame;
in response detecting the user interaction, repositioning the user selected section of content from a first position within the document to a second position within the document;
determining a position within the document to insert a page break by:
scanning, within a document editing application, a document to detect one or more columns;
calculating, for each respective column of the one or more columns, a column height based on a first distance between a top edge of the document, and a first bottom edge of the each respective column;
storing the column height for the each respective column of the one or more columns in an array;
detecting a user edit to content of the document;
in response to detecting the user edit to the content of the document, inserting a page break into the document by:
calculating, for each sequential lines of text within the each respective column, a text line height corresponding to a second distance between the top edge of the document, and a second bottom edge of a lowest positioned text element within the each sequential text line;
detecting a first sequential text line, where the text line height of the first sequential text line exceeds the column height of the respective column containing the first sequential text line; and
inserting the page break into the document, the page break positioned after a left-most element of a previous sequential text line preceding the first sequential text line; and
generating a visual display element indicating a position of the page break within the preview comprising the multiple pages of the document.

18. The method of claim 17, further comprising:
detecting one or more additional page breaks associated with the one or more columns, wherein the one or more additional page breaks are misaligned horizontally with respect to the inserted page break; and
modifying a vertical position of the one or more additional page breaks to horizontally align the one or more additional page breaks with the inserted page break.

19. The method of claim 17, further comprising, in response to detecting the user interaction, temporarily hiding one or more existing page breaks within the document.

20. The method of claim 17, wherein the visual display element indicating the position of the page break is generated by executing a javascript.
